(19) United States
(12) Patent Application Publication
(10) Pub. No.: US 2015/0269696 A1
(43) Pub. Date: Sep. 24, 2015

(54) PAYOR-REIMBURSABLE METHOD OF TRANSFORMING CLINICAL COMMUNICATION INTO A PERSON-CENTERED EXPERIENCE

(71) Applicant: Hopecare, Inc., Chapel Hill, NC (US)

(72) Inventor: John Stonestreet, Chapel Hill, NC (US)

(73) Assignee: Hopecare, Inc., Chapel Hill, NC (US)

(21) Appl. No.: 14/218,974

(22) Filed: Mar. 19, 2014

(51) Int. Cl. G06Q 50/22; G06Q 30/04

(52) U.S. Cl. CPC G06Q 50/22; G06Q 30/04

(57) ABSTRACT

This invention is a payor-reimbursable method for engaging clinical communication with patients and families to alleviate communication flow problems associated with conflicts between biomedical scientific and other healing paradigms. Through the method, payor reimburses physician and/or other clinician to both deliver the medical information included in biomedical paradigm utilizing the languages rooted in the cultures of science and statistics and to determine whether patient and/or surrogate experience and/or decisions are influenced by any paradigm other than biomedical scientific paradigm, to determine whether expression of hope and/or prayer is an intervention important to patient/surrogate/family healthcare decision making, and, when appropriate, to provide hopeful and/or prayerful religious or spiritual or emotional intervention from spiritual or religious or emotion-based paradigm, using that paradigm's language to express desire and/or request for outcome deemed wrong headed, unlikely, or impossible by medicine but believed and/or hoped virtuous, likely, or possible by patient/surrogate/family.

### BACKGROUND OF THE INVENTION

The present invention relates to the field of reimbursable end-of-life healthcare communication, including conversations surrounding hope, care, diagnosis, prognosis, treatment, and decision making.

At the present time, more than 75% of Americans believe that people who are given no chance of survival by medical science can be cured through divine intervention (Cadge, 2012). Studies show that this population is less likely to trust physician and/or other clinician and/or other clinicians' prognosis and more likely to request continued life support against physician and/or other clinician recommendations (Zier, 2009). Clinician reports and studies also show that many physicians and/or other clinicians are hesitant to explore nonscientific alternatives to aggressive treatment even which such treatment has a low likelihood of success. (Wachter, 2012). Earlier on, and even well in to the disease trajectory, the exclusively scientific paradigm offers few possibilities for even imagining viable alternatives to pathways of aggressive treatment. Heart doctors report that they are afraid to introduce palliative care because they don't want patients and families to perceive that they are “giving up” (Kavalieratos, 2012), and oncologists report that they are similarly hesitant to discuss the possibility of treatments being unsuccessful because they claim that they don't want patients to “lose hope” (Morris, 2004).

Later, when physicians do finally give up, they often either shirk communication altogether or insensitively impose scientific reality on patients and families who by this point in the aggressive regimen, struggle to metabolize the often sudden abandonment. Additionally, research shows that when the scientific perspective of physician and/or other clinicians clashes with the religious perspective of patients and families, conflict often arises (Cadge, 2012) and misunderstandings resulting from paradigm clashes preclude progress toward agreement (Mattingly, 2010). There exists no known mutually beneficial resolution for these conflicts and misunderstandings. As mentioned, the most common alternative to conflicts is avoidance of seriously engaging the conversation at all stages of the disease trajectory (Kavalieratos, 2012; Morris, 2004; Wachters, 2012; Gawande, 2010).

Both conflict and avoidance prevent or obfuscate a kind of communication necessary to transform one-dimensional discussions of prognostication into patient/family-centered contexts for healthcare decision making. Transformation of these contexts will, when considered in masse, empower sustainable, intentional and reflective health care decisions both that the economy can afford and that families do not regret in hindsight. Regarding regrettable, unreflective decisions, research also shows that while the majority of Americans indicate that they want to die at home, the majority do not end up dying at home. Furthermore, patients with intensive life prolonging care at the end of life report a lower quality of life at the end of life (Balboni, 2011) and their families suffer greater levels of post-traumatic stress after their death (See Prigerson et al. 2008-2014, Harvard). When the problem manifests as avoidance, everyone loses, and emotional and financial costs are aligned for the patient, family, and healthcare system. When the problem manifests as conflict, everyone loses again, and physician and/or other clinician and/or other clinicians can feel frustrated that their expertise is not respected and/or helpless to translate their scientific reasoning into a language that is persuasive to religious patients and/or families (Mattingly, 2010).

This frustration often boils over as reported by Ofri (2013) where the physician had become confident in medical futility and became “so angry” at the family for resisting that she “wanted to scream.” So angry in fact that “there were times when she could barely stand to make eye contact with them.” In the case of conflict, patients and/or can families feel angry and/or hurt that their faith perspective is not honored, and/or helpless to translate their spiritual perspective into language that is persuasive to a physician and/or other clinician and/or other clinician who either does not share their faith or who does not identify with how they are marshalling their faith in this context. In the case of avoidance, patients and families need the physician and/or other clinician and/or other clinician to identify and create a physical space for what Babrow (1992; 2001; 2007) calls “evaluative orientations.”

According to Cassell (2005), the non-scientific paradigm including communication of compassion, emotion, spirituality, religion, ethics, values, etc., falls by the wayside especially when it is needed most, in life-limiting illness, intensive care, end-of-life care, etc. because it carries no reimbursement productization and value and therefore is not, for example, assigned value under “relative value units” (RVUs). With “expenses rising and reimbursement shrinking, it is difficult to justify ‘uncompensated faculty time,’ which means time spent talking” about the non-scientific paradigmatic aspects of healthcare decision making. “Consequently,” continues Cassell, “in most academic ICUs in the United States—unless an ICU team has been specifically funded to study compassionate care at the end of life and devise innovations to improve it—communicating with families and helping patients to die ‘a good death’ are not considered part of the professional responsibilities of critical care physicians. These responsibilities are private; their fulfillment depends on the ethical sensibilities of each intensivist. As F. Scott Fitzgerald's Gatsby observed about his adored Daisy's love for her husband, it's ‘just personal.’

Because the process of making compassionate decisions at the end of life and communicating well with families are defined as persona and optional, they are not imparted to residents as crucial techniques that should be mastered by every physician. (To repeat: Neither the practice nor the teaching of these are recompensed; they involve uncompensated faculty time.) In the Midwest SICU, I observed only one of the seven intensivists discuss these ethical and communication issues and teach residents how to make decisions and talk to families.” According to that intensivist, there are two different kinds of decisions. “There's the personal decision: Do you want to continue therapy? Then there's the medical decision, which is separate: Is further therapy futile? The doctors must ask the right questions [of the family], said Hunt.” Because the personal decision includes nonscientific factors, there is no productization and reimbursement around this vital aspect.

While on the one hand that may seem understandable, given the reality of increased expenses and shrinking reimbursement, there are actually studies that confirm the intuitive reality that transformative communication covering the non-scientific paradigm aspects of healthcare decisions may be the single most significant quality/cost boon for the future sustainability of the US healthcare system. For example, Balboni (2011) finds that spiritual support by the medical team significantly decreases the cost of care in the last week of life. One would think that results such as this would more than merit reimbursement, but this is just one isolated finding amid the deluge of health outcomes research.

Because there is no patent for this domain, there is no business case for investment in the kinds of randomized clinical trials and other significant studies that can create a value proposition for this kind of care being anything other than Gatsby's observed “it's ‘just personal,’” or just elective if a physician feels like it, and has the time to donate to such difficult and uncompensated work. “On the rare occasions when these subjects were broached during rounds,” observes Cassell, “the residents listened with apparent interest. I suspect many residents want to learn how to handle death and dying with knowledge and empathy, how to demonstrate compassion and caring, how to communicate more effectively with families using plain English rather than medi-speak. Caring for people is why many young people go into medicine in the first place. During their training, however, young doctors are trained to transform patients stories into cases, to ‘prioritize,’ dealing with technical matters before they devote time to emotional factors (if, indeed, they have the time to devote), and to think about patients in technical language valued by their superiors, a language that has no words or spaces for feelings.”

This application adds italics to the word “transform” in the previous sentence, because a part of what is background section is demonstrating is that what is needed is a patented method for a reverse transformation in order to ensure that all dimensions of both scientific and non-scientific paradigms are valued, honored and addressed in communication surrounding the healthcare decision making process. In her ethnographic observations, Cassell (2005) “heard no intensivist express pride in how well the unit handled dying or communicated with families; this was in striking contrast to the doctors' self-esteem regarding their technical expertise. As one intensivist declared to residents during rounds: ‘Our ICU, our school, our university is at the cutting edge of everything!’ The cutting edge' refers to knowledge of the latest findings in their field and expert deployment of the most advanced drugs and technology. Compassion and communication have no cutting edge: these old-fashioned medial virtues are either present or absent. The doctors were justifiably proud of the patients they saved who might have died in less-skilled ICUs, but no pride was expressed in what went on with patient and family when they lost someone.”

“One of the SICU co-directors was interested in end-of-life issues; he talked compassionately and truthfully with families. He did not realize, however, how clearly his tone of voice and body language indicated discomfort and impatience to move on to the next task. I rarely observed the second co-director converse with family members, and he showed little apparent interest in or knowledge about the personal characteristics of patients and families. He delivered admirable informed technical care but impressed me as somewhat uncaring.” Cassel observes that the lack of care was often attributable to a lack of time which itself is attributable to a lack of reimbursement. And again, reimbursement requires investment, and a business case to justify investment requires a patent. In this sense it could be provocatively and admittedly grandiosely argued, (if the reader may begged to forgive the pathetic arrogance of such grandiosity for the purpose of consideration) that the future sustainability of the US healthcare system is dependent on whether or not this patent is awarded and successfully litigated. Only then will there become a “cutting edge” of, and greater prevalence of, and pride in, non-scientific communication necessary for sustainable healthcare decision making.

All of this, and nothing short of this, will justify the requisite growth of this vital dimension of medical education and on-going life-long training. Without this, as Cassell observes, initiatives in this domain are limited to occasional and time-limited grants oriented in this direction which are even more rare than the physicians who take the initiative and donate the time to this unproductized, unpatented, unreimbursed, and therefore uncompensated work. Reflecting on the paradoxical place of care in the healthcare settings she observed, Cassell emphasizes that “despite the hospital's slogan—”we care“—caring was not part of the SICU's institutional policy; it was exhibited by nurses, or by doctors as part of ‘uncompensated faculty time.’” “In other words,” observes Cassel, “in academic medical center ICU's, not only are there no institutional mechanisms to encourage communication with families and compassionate (as well as technically accomplished) end-of-life care, there are institutional constraints against teaching and delivering such care. Recalling the sustainability argument above, Cassell argues, citing Fox and Swazey (1992), that a “limitless battle against death leads only to human suffering, and social, cultural, and spiritual harm.”

To that list of harms must be added the financial harm of an unsustainable healthcare system rooted in such a “limitless battle.” The invention contained herein is precisely what is necessary to most caringly and sustainably navigate the limits of medicine's battles against death. Citing Crippen (2002), Cassel identifies the tragedy that, in a healthcare system exclusively on a scientific paradigm, “failure to prevent [death is] defined as therapeutic failure.” According to that definition of therapy, there can be nothing therapeutic about human well-being in the dying process; such a state of well being is unseen by the label “therapeutic failure.” While hospitals are going in investing in palliative care and hospice services and referrals, the problem of [p]roviding compassionate ICU care of patients and families at the end of life is not entirely amenable to individual solutions” because “the problem is systemic.”

“We know some of the ways dying can be made less agonizing for patients and families,” observes Cassell, “and we are constantly learning more. We have learned about drugs and techniques to assure comfort from the moment patients enter the ICU to the time they leave, whether that departure involves survival or death. We are learning how to conduct conferences with families to inform them about the condition of the patient and to educate and support family members in helping them make difficult decisions about shifting from heroic to comfort care. We know that families want more information than they generally receive from doctors and that frequent updates help build a reservoir of trust that facilitates decision making at the end of life. We know that young doctors must learn how to care for dying patients and talk to families. Some of us also realize: ‘Efforts to provide a “good death” for patients and their families require close attention to not just their informational and decision making needs, but also their emotional, spiritual and psychological needs.’ All of this takes time. And unless a medical center has a grant to study and devise innovative responses to these problems,” which itself is time and resource limited, “time is exactly what today's hard-pressed ICU physicians, [as well as oncologists and most all physicians of any specialty] do not have. They are busy racking up clinical RVUs calculated in terms of activities compensated by Medicare, writing grant requests and conducting research attempting to generate funds to cover their salaries and expenses.”

In the status quo world where doctors are only reimbursed to “disseminate the notion that a technological fix will bring us closer to eternal life,” we ultimately “pay the price” for the unsustainable nature of a system where productizable, patentable, investment-worthy, and reimbursable care for the nonscientific dimensions of healthcare, namely “cutting edge” communication, and at the end of the day “society will pay the price,” a price the US economy cannot afford. “We as a society,” exhorts Cassel, “must follow the money—and put our money where our mouths are” (Cassel, 2005). The first step in that direction is the success of this patent.

The current deployment of spiritual and religious care in hospitals does not and cannot solve the spiritual and religious aspects of this problem for several reasons: There are not enough chaplains to cover each of these cases. Even if there were enough chaplains to follow up on each of these cases after the fact, this is a “point of care” exigency requiring in-the-moment spiritual attention to the spiritual aspects of care. Even if there were enough chaplains to be involved in every physician and/or other clinician and/or other clinician conversation where a terminal diagnosis or prediction of futility prognosis is delivered, most hospital chaplains are not able to mitigate these conflicts for a number of reasons (Cadge, 2012).

Even if none of the above were true, the fact remains, documented by research, that hospitals do not even attempt to engage their existing chaplains either proactively or retroactively for these conflicts (Cadge, 2012). One of the reasons for this is that, because hospital chaplains are necessarily bound by a professional code of nonproselytizing due to the secular nature of the health care context, the hospital chaplaincy profession attracts more liberally minded spiritualists who do not identify either with the religious, or other hopeful, perspective of hoping for a divinely granted miraculous cure when medical science gives no chance of survival, or sometimes even with the religious, or other hopeful, perspective of deliberately choosing to resign oneself to whatever God or fate, or chance, etc., might bring at the time of life threatening diagnosis, rather than opting for curative treatment, even if it is highly likely to be successful. The previous disconnect is evident to some patients and families when chaplains respond to their requests for prayer with prayers containing broad generalizations about healing and peace that do not identify with the specific request for prayer for miraculous physical healing. This disconnect thwarts the possibility of communicative transformation.

Even if chaplains were able to identify with this patient/family religious perspective, the reality remains that the decisional conflict is germane to the physician and/or other clinician and/or other clinician relationship on which hinges patient/family trust and ultimately healthcare decision making. Therefore, what is needed is a point-of-care, physician and/or other clinician and/or other clinician-provided intervention to bridge the divide between medical prognostication and religious, or other non-scientific and/or non-scientifically curative hope. This payor reimbursable method will transform, among other things, the otherwise unresolvable conflicts stemming from the role of religious hope in communication surrounding predictions of medical futility, into a person-centered experience accessible to the healing paradigm translated into the cultural language of the 75% of the US population which believes that people who are given no chance of survival by medical science can be cured through divine intervention (Cadge, 2012).

### BRIEF SUMMARY OF THE INVENTION

The present invention is a payor-reimbursable method for managing clinical prognostication with patients and families to alleviate communication flow problems associated with individuals each operating on different decision making paradigms, each speaking different languages rooted in the respective culture of each paradigm (Mattingly, 2010), and each navigating the decision process from his or her own paradigm. Through this method, the physician and/or other clinician and/or other clinician delivers the medical information included in the biomedical scientific paradigm utilizing the languages rooted in the cultures of biomedicine and statistics, the physician and/or other clinician and/or other clinician determines whether the patient and/or surrogate decisions are influenced by any paradigm other than the biomedical scientific paradigm, the physician and/or other clinician and/or other clinician determines whether an expression of hope and/or prayer is an intervention important to patient/surrogate/family healthcare decision making, and, when appropriate, the physician and/or other clinician provides a hopeful and/or prayerful religious or spiritual intervention from a hopeful, humanist, spiritual or religious, or other paradigm, using language from that paradigm to specifically express a desire, and/or a request, and/or compassion for a care trajectory that is deemed inadvisable, or an outcome that is deemed unlikely or impossible by medical science but believed and/or hoped to be virtuous, likely, or possible by the patient/surrogate/family.

### BRIEF DESCRIPTION OF THE DRAWINGS

FIG. 1. FIG. 1 shows a novel design for a projector where the bulb (10) is on the larger plane/side (15) of the device and therefore the device is made to stand vertically rather than horizontally, supported by a vertical base, such as a human being through connectors at the top (20) and the back (25). The ports for various media and other electronic connections are pictured at the bottom (30) of the device on the plane/side that would usually house a bulb on other projectors.

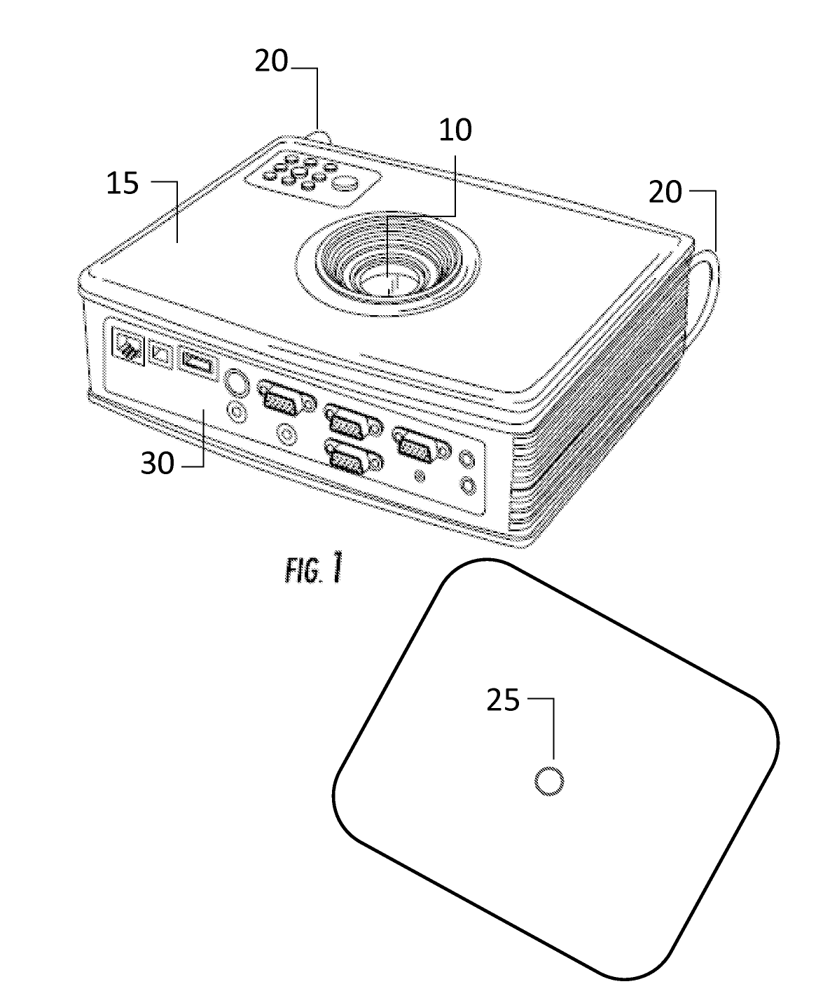

FIG. 2. FIG. 2 illustrates the projector from FIG. 1 attached to a human being and shows a novel design for a medical white coat with a strap(s) (40) that drop(s) down to attach to a connectors (42) and a specially shaped button (45) that functions as a connector for devices and/or device casings such as the projector in FIG. 1 or a tablet casing in FIG. 3.

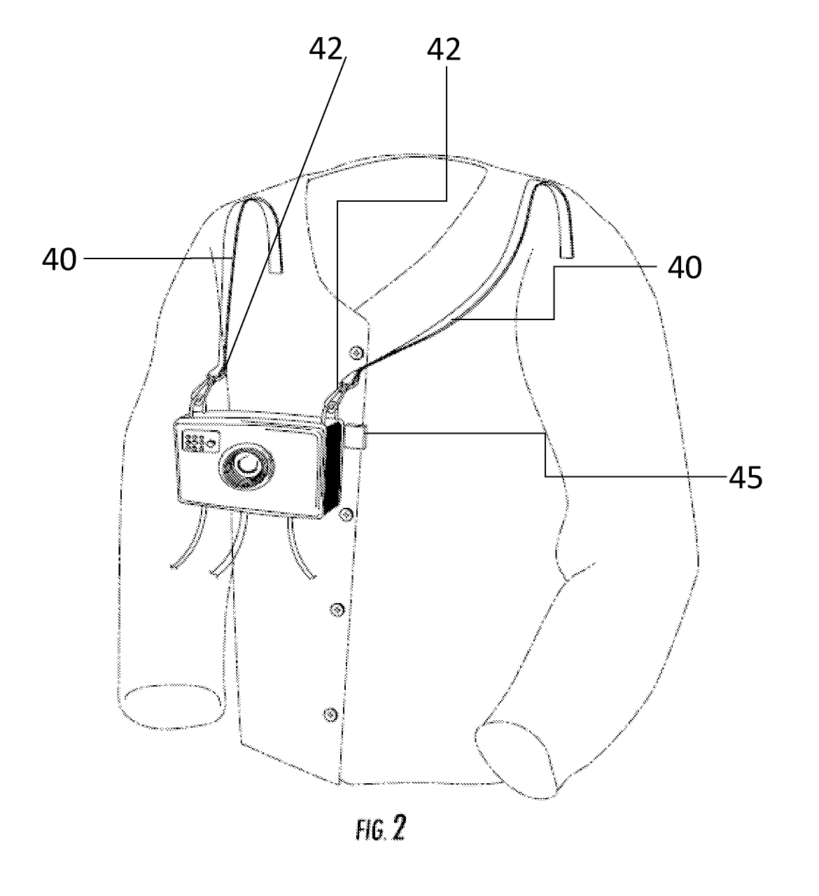

FIG. 3. FIG. 3 illustrates the casing (50) for a computer tablet device with connectors (55) at the top and a connector (60) on the back.

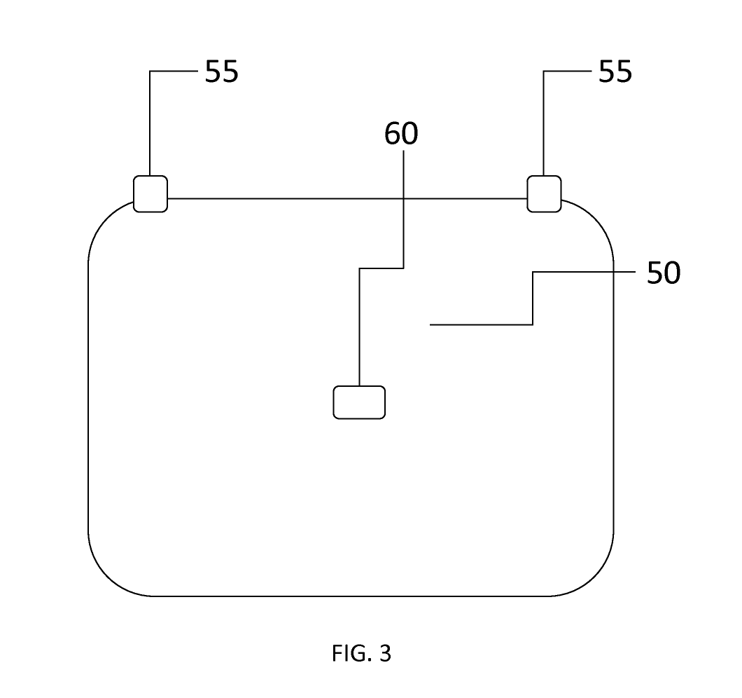

### DETAILED DESCRIPTION AND BEST MODE OF IMPLEMENTATION

The present invention is a payor-reimbursable method for engaging clinical prognostication conversations with patients and families to alleviate communication flow problems associated with conflicts between biomedical scientific and spiritual/religious healing paradigms. Through this method, payors provide reimbursement to compensate for a physician and/or other clinician and/or other healthcare professional to deliver the medical information included in biomedical paradigm utilizing the languages rooted in the cultures of science and statistics, for a physician and/or other clinician and/or other healthcare professional to determine whether patient and/or surrogate decisions are influenced by any paradigm other than biomedical scientific paradigm, for a physician and/or other clinician and/or other healthcare professional to determine whether expression of hope and/or prayer is an intervention important to patient/surrogate/family healthcare decision making, and, when appropriate, for a physician and/or other clinician and/or other healthcare professional to provide hopeful and/or prayerful religious or spiritual intervention, or humanist or other intervention from spiritual or religious or humanist or other paradigm, using that paradigm's language to express desire, and/or request, and/or compassion for a care trajectory deemed inadvisable by medical science or an outcome deemed unlikely or impossible by medical science but believed and/or hoped virtuous, or likely, or possible by patient/surrogate/family.

If the reader will forgive the poor form from a novice patent application writer, what follows is a list of the claims with additional commentary in a different font.

Claim One: A payor-reimbursable method for a health care provider to engage communication surrounding diagnosis, treatment decisions, and prognostication, and/or any other communicative facet of care, between the physician(s)—and/or the other clinician(s), and/or the health care professional(s)—and a patient(s) and/or a family member(s), and/or a surrogate(s), the method comprising:

Establishing and using a payor code(s) for a recognition of, and a reimbursement for, and an exclusive reimbursement on an on-going and a perpetual basis for:

A preventing, and/or an addressing, and/or an alleviating, and/or an exploring of a possibility of a communication problem(s) and/or a communication challenge(s), and/or a communicative reality(ies), and/or a communicative appearance(s) associated with a possibility of an individual(s) and/or a group(s) operating, whether implicitly or explicitly, on a wholly, or a somewhat different paradigm(s) for a navigation of—and/or a wholly, or a somewhat different understanding(s) of, and/or a reality(ies) for—what constitutes an experience of, and/or an expression of, and or a provisioning of health “care”, and what a type(s) of, and/or an expression(s) of communication is a constituent of a communicative process(es) of heath care and/or is important for a health care decision(s) and/or a decision process(es), each navigating the care experience, and/or the decision, and/or the decision process, and/or the communication surrounding the care experience, and/or the communication surrounding the decision, and/or the communication surrounding the decision process from his, and/or her, and/or their own understanding(s), and/or paradigm(s), and/or reality(ies);

Implementing a communication protocol that combines a providing of medical information from a scientific paradigm with a scrupulous intentionality around seeking out an awareness of—and a scrupulous intentionality around endeavoring to communicatively care for, and/or a provision for the communicative resources appropriate for caring for—a patient(s), and/or a family member(s), and/or a surrogate(s) with regard to their a paradigm(s), and/or their an understanding(s), and/or their a reality(ies) of/for what might constitute a health “care” experience and what a kind(s) of, and/or an expressions of, a communication(s) might be a constituent of a communicative process(es) of the heath care experience and/or important for a health care decision and/or a decision process.

Claim two: The method recited in claim 1, wherein the medical information provided from the scientific paradigm includes a complete and full delivery of the information included in the scientific paradigm, disclosed as completely, fully, directly, and clearly as possible, limited only by ethics, standards of care, and limits imposed as a result of direct, preliminary inquiry into how much the patient and/or family/surrogate wants to know and how they want that information to be conceptualized and/or expressed. In other words, people need to understand as well as possible exactly what is going on in their bodies and what the implications of this may be so that they can have the information they need to evaluate what it is they want to do going forward. Without hearing clearly and directly the information from the scientific paradigm, people will never be in a position to evaluate whether or not they really want to move forward with treatment and, if so, how much treatment. To put it in provocative terms, the status quo path of hush, hushing reality to keep people hopeful while science engages a violent war against mortality inside their bodies, holding them captive to its wiles and not letting go until it is satisfied that they are a lost case, in which case they are encouraged to give their bodies to science even as they are encouraged to disconnect their non-scientific hopes is, while amazing in many ways, awfully one-noted, not right for everyone, quite harmful for many, and woefully unsustainable both emotionally and economically. Therefore, we must make a better effort to get the bad news out in the diagnostic phase rather than waiting until it is time to remove a ventilator for another technologized death.

Claim three: The method cited in claim 1, wherein the
scrupulous intentionality around endeavoring to communicatively care for, and/or provision for the communicative resources appropriate for caring for—a patient(s), and/or a family member(s), and/or a surrogate(s) with regard to their a paradigm(s), and/or their an understanding(s), and/or their a reality(ies) of/for what might constitute a health “care” experience and what a kind(s) of, and/or an expressions of, a communication(s) might be a constituent of a communicative process(es) of the heath care experience and/or important for a health care decision and/or a decision process.

includes a determining, through a scrupulously intentional inquiry, whether the patient(s), and/or the family(s), and/or the surrogate(s) value a paradigm other than the scientific paradigm. In other words, something along these lines should be asked. Is there anything other than the medical information that is important for you in this process?

Claim 4: The
determining, through a scrupulously intentional inquiry, whether the patient(s), and/or the family(s), and/or the surrogate(s) value a paradigm other than the scientific paradigm,
recited in claim 3, wherein the determining specifically includes an explicit inquiry into whether a religious, or spiritual, or humanist or another kind of alternative paradigm might be valued. Something along these lines can be asked: Do you have any religious, or spiritual, or humanist commitments, traditions or values that are important to your experience of this illness and the care that you would like for us to share with you?

Claim 5: The method recited in claim 1, wherein, the determining specifically includes an explicit inquiry into what might be the patient(s), and/or the family(s), and/or the surrogate(s) hope(s) at this time and a query as to how those hopes might be best supported and what the physician, and/or other clinician, and/or health care professional can do to help support existing hopes. What are your hopes at this time? How can we best help to support your hopes?

Claim 6: The method recited in claim 4, wherein, if a religious or a spiritual paradigm is valued, then an inquiry as to whether a prayer is an intervention important to patient/surrogate/family experience of care. Given that your faith is important to you, is there any specific way that we could support you in your faith, whether through prayer or some other means?

Claim 7: The method recited in claim 6, wherein an inquiry is made into a specific prayer content, whether a specific request(s) and/or a specific expression(s) is desired, and then a prayer is offered according to the request if the inquiry finds interest. What would you like to prayer for at this time? Shall we pray together now (or in the case of a non-religious clinician or a difference in religion between the clinician and the patient/family/surrogate, a technology-enabled (as we will see provisioned for below) prayer can be provided in the moment with the clinician staying present, and then a referral for spiritual support can be made subsequent to this point-of-care intervention. This is vitally important as Balboni (2011) found that spiritual support from the medical team impacts quality and cost outcomes more than spiritual support from chaplains alone.

Claim 8: The prayer recited in claim 7, wherein the prayer includes specific elements, and/or a specific structure that incorporates both the specific prayer content and the elements and structure already prepared as long as the two are complementary.

Claim 9: The prayer including specific elements and/or a specific structure recited in claim 8, wherein, among other possible elements and structures, a version of such a prayer includes the elements of an expression of belief in and/or a hope for a miracle(s), an acknowledgement of uncertainty, and a request for an experience of God's presence, structured in that order.

Claim 10: The prayer including specific elements and/or a specific structure recited in claim 9, wherein, the request for an experience of God's presence is coupled with an expression, for Christian patient(s), and/or family(ies), and/or surrogate(s), of God's cruciform identity in Christ as one who suffers both for us and also with us, in our sufferings.

Claim 11: The inquiry in claim 5, wherein an effort is made to offer a communication supporting existing hopes through a variety of means including an appropriate expression of a desire for hope and/or a compassion for existing hopes.

Claim 12: The effort in claim 11, wherein after the support is offered for existing hopes, an inquiry is made into whether there may be any interest, now or in the future, in the possibility of imagining and/or exploring any additional hopes.

Claim 13: The method in claim 1, wherein the provision for the communicative resources appropriate for caring comprises a device(s) and/or a system(s) for provision of communicative resources.

Claim 14: The device in claim 13, wherein the device comprises at least one projector.

Claim 15: The projector in claim 14, wherein the projector is a novel design such that, unlike other projectors, it is designed with the bulb in the larger plane so that it can readily be positioned vertically rather than horizontally and stabilized by an attachment to a vertical plane rather than horizontal one.

Claim 16: The projector in claim 15, where the vertical plane that the projector is attached to is a human being through a connector on the back of the projector, another connector on the top of the projector, and an attachment system.

Claim 17: The attachment system in claim 16, wherein the system comprises a white coat made especially with a novel button for attachment to the connector on the back of the projector and a stabilizing strap(s) for attachment to the top of the projector.

Claim 18: The system in claim 13, wherein the system is comprised of a computer tablet case with a connector on the back of it which can be attached to the novel button connector from claim 17, and connectors on the top of it which can be attached to the stabilizing strap(s) from claim 17.

Claim 19: The method in claim 1, wherein the provisioning for the communicative resources comprises:
A human being wearing a projector or a computer tablet on the front of his/her body and thereby functionally providing by projecting and/or displaying the communicative care that is needed from that human being whether or not that human being is able to provide such care on his/her own;
A projector that will project recorded communicative interventions;
A projector that will project live communicative interventions through internet enablement;
A connectable case for a tablet that will display recorded communicative interventions;
A connectable case for a tablet that will display live communicative interventions through internet enablement.

Claim 20: The method recited in claim 1, wherein the providing of medical information is done with a qualifying caveat regarding the potential for embedded frames of the scientific paradigm and/or the limitations of the scientific paradigm.

In one embodiment of the prayer, physician and/or other clinician distributes text of the intervention and asks
surrogate/family members to verbally perform intervention while physician and/or other clinician and/or other clinician remains
present. In another embodiment, physician and/or other clinician and/or other clinician distributes text of intervention for patient
and/or family to perform at another time. In another embodiment, physician and/or other clinician and/or other clinician verbally
performs the textual intervention along with patient and/or family. In another embodiment, physician and/or other clinician and/or other clinician verbally performs the intervention for the patient and/or family
without recourse to textual material. In another embodiment, physician and/or other clinician and/or other clinician brings in a third
party to lead the verbally performed intervention with or without textual reference, and with or without patient and/or family verbally participating. In another embodiment, physician and/or other clinician and/or other clinician plays pre-recorded audio of intervention for patient and/or family through cd,
mp3 or other audio format. In another embodiment, physician and/or other clinician and/or other clinician plays pre-recorded video
of the intervention for patient and/or family through dvd, mpeg or other video format. In another embodiment, physician and/or other clinician and/or other clinician uses projection technology to display prerecorded audio and/or video of the intervention. In another embodiment, physician and/or other clinician and/or other clinician uses mobile phone or
smartphone with or without projection technology to play pre-recorded audio or video of the intervention. In another embodiment, physician and/or other clinician and/or other clinician uses live audio or videoconferencing
via mobile smartphone, ipad-sized tablet device, laptop or computer to conference in a third party who may deliver the intervention live with/for the patient and/or family. Projection technology is also an option with this embodiment as detailed in the figures.

As previously stated in U.S. Pat. No. 8,610,726, and also applicable for this patent application: “The foregoing merely illustrates certain principles of the invention. Various modifications and alterations to the described embodiments will be apparent to those skilled in the art in view of the teachings herein. It will thus be appreciated that those skilled in the art will be able to devise numerous [devices], systems, arrangements and methods which, although not explicitly shown or described herein, embody the principles disclosed in this document and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.”

The following are hereby incorporated by reference:
Balboni T, Balboni M, Paulk E, et all. Support of cancer patients' spiritual needs and associations medical care costs at the end of life. Cancer. 2011 Dec. 1; 117(23): 5383-5391. doi:10.1002/cncr.26221.
Cadge, Wendy (2012). Paging God: Religion in the Halls of Medicine. Chicago, Ill.: The University of Chicago Press.
Cassel, J. (2005). Life and Death in Intensive Care. Philadelphia: Temple University Press. Gawande, A. (2010). “Letting go.”
http://www.newyorker.com/reporting/2010/08/02/100802fa_fact_gawande?currentPage=all Kavalieratos, D. (2012). http://sph.unc.edu/hpm-doctoral-student-honored-by-american-academy-of-hospice-and-palliative-medicine/
Mattingly, C. (2010). The paradox of hope: Journeys through a clinical borderland. Berkeley: University of California Press.
Morris, V. (2004). Talking About Death. Chapel Hill, N.C.: Algonquin Books.
Ofri, D. (2013). What Doctors Feel: How Emotions Affect the Practice of Medicine. Boston: Beacon Press.
Wachter, B. (2012). Denying Reality About Bad Prognoses, http://thehealthcareblog.com/blog/2012/11/19/denying-reality-about-bad-prognoses/#comments.
Zier, L. S., Burack, J. H., Micco, G., Chipman, A. K., Frank, J. A., Luce, J. M., White, D. B. (2008). Doubt and belief in physicians' ability to prognosticate during critical illness: the perspective of surrogate decision makers. Critical Care Medicine, 36(8), 2341-7.

Zier, L. S., Burack, J. H., Micco, G., Chipman, A. K., Frank, J. A., Luce, J. M., White, D. B. (2009). Surrogate Decision Makers' Responses to Physicians' Predictions of Medical Futility. Chest, 136(1), 110-117.

I claim:

1. A payor-reimbursable method for a health care provider to manage communication surrounding diagnosis, treatment decisions, and prognostication, and any other communicative facet of care, between the care provider and care recipient, the method comprising:
Establishing and using a payor code(s) for a recognition of, and a reimbursement for, and an exclusive reimbursement on an on-going and a perpetual basis for:
A preventing, and/or an addressing, and/or an alleviating, and/or an exploring of a possibility of a communication problem(s) and/or a communication challenge(s), and/or a communicative reality(ies), and/or a communicative appearance(s) associated with a possibility of an individual(s) and/or a group(s) operating, whether implicitly or explicitly, on a wholly, or a somewhat different paradigm(s) for a navigation of—and/or a wholly, or a somewhat different understanding(s) of, and/or a reality(ies) for—what constitutes an experience of, and/or an expression of, and or a provisioning of health “care”, and what a type(s) of, and/or an expression(s) of communication is a constituent of a communicative process(es) of heath care and/or is important for a health care decision(s) and/or a decision process(es), each navigating the care experience, and/or the decision, and/or the decision process, and/or the communication surrounding the care experience, and/or the communication surrounding the decision, and/or the communication surrounding the decision process from his, and/or her, and/or their own understanding(s), and/or paradigm(s), and/or reality(ies);
Implementing a communication protocol that combines a providing of medical information from a scientific paradigm with a scrupulous intentionality around seeking out an awareness of—and a scrupulous intentionality around endeavoring to communicatively care for, and/or a provision for the communicative resources appropriate for caring for—a patient(s), and/or a family member(s), and/or a surrogate(s) with regard to their a paradigm(s), and/or their an understanding(s), and/or their a reality(ies) of/for what might constitute a health “care” experience and what a kind(s) of, and/or an expressions of, a communication(s) might be a constituent of a communicative process(es) of the heath care experience and/or important for a health care decision and/or a decision process.

2. The method recited in claim 1, wherein the medical information provided from the scientific paradigm includes a complete and full delivery of the information included in the scientific paradigm, disclosed as completely, fully, directly, and clearly as possible, limited only by ethics, standards of care, and limits imposed as a result of direct, preliminary inquiry into how much the patient and/or family/surrogate wants to know and how they want that information to be conceptualized and/or expressed;

3. The method recited in claim 1, wherein the scrupulous intentionality around endeavoring to communicatively care for, and/or provision for the communicative resources appropriate for caring for—a patient(s), and/or a family member(s), and/or a surrogate(s) with regard to their a paradigm(s), and/or their an understanding(s), and/or their a reality(ies) of/for what might constitute a health “care” experience and what a kind(s) of, and/or an expressions of, a communication(s) might be a constituent of a communicative process(es) of the heath care experience and/or important for a health care decision and/or a decision process.
includes a determining, through a scrupulously intentional inquiry, whether the patient(s), and/or the family(s), and/or the surrogate(s) value a paradigm other than the scientific paradigm.

4. The determining, through a scrupulously intentional inquiry, whether the patient(s), and/or the family(s), and/or the surrogate(s) value a paradigm other than the scientific paradigm,
recited in claim 3, wherein the determining specifically includes an explicit inquiry into whether a religious, or spiritual, or humanist or another kind of alternative paradigm might be valued.

5. The method recited in claim 1, wherein, the determining specifically includes an explicit inquiry into what might be the patient(s), and/or the family(s), and/or the surrogate(s) hope(s) at this time and a query as to how those hopes might be best supported and what the physician, and/or other clinician, and/or health care professional can do to help support existing hopes.

6. The method recited in claim 4, wherein, if a religious or a spiritual paradigm is valued, then an inquiry as to whether a prayer is an intervention important to patient/surrogate/family experience of care.

7. The method recited in claim 6, wherein an inquiry is made into a specific prayer content, whether a specific request(s) and/or a specific expression(s) is desired, and then a prayer is offered according to the request if the inquiry finds interest.

8. The prayer recited in claim 7, wherein the prayer includes specific elements, and/or a specific structure that incorporates both the specific prayer content and the elements and structure already prepared as long as the two are complementary.

9. The prayer including specific elements and/or a specific structure recited in claim 8, wherein, among other possible elements and structures, a version of such a prayer includes the elements of an expression of belief in and/or a hope for a miracle(s), an acknowledgement of uncertainty, and a request for an experience of God's presence, structured in that order.

10. The prayer including specific elements and/or a specific structure recited in claim 9, wherein, the request for an experience of God's presence is coupled with an expression, for Christian patient(s), and/or family(ies), and/or surrogate(s), of God's cruciform identity in Christ as one who suffers both for us and also with us, in our sufferings.

11. The inquiry in claim 5, wherein an effort is made to offer a communication supporting existing hopes through a variety of means including an appropriate expression of a desire for hope and/or a compassion for existing hopes.

12. The effort in claim 11, wherein after the support is offered for existing hopes, an inquiry is made into whether there may be any interest, now or in the future, in the possibility of imagining and/or exploring any additional hopes.

13. The method in claim 1, wherein the provision for the communicative resources appropriate for caring comprises a device(s) and/or a system(s) for provision of communicative resources.

14. The device in claim 13, wherein the device comprises at least one projector.

15. The projector in claim 14, wherein the projector is a novel design such that, unlike other projectors, it is designed with the bulb in the larger plane so that it can readily be positioned vertically rather than horizontally and stabilized by an attachment to a vertical plane rather than horizontal one.

16. The projector in claim 15, where the vertical plane that the projector is attached to is a human being through a connector on the back of the projector, another connector on the top of the projector, and an attachment system.

17. The attachment system in claim 16, wherein the system comprises a white coat made especially with a novel button for attachment to the connector on the back of the projector and a stabilizing strap(s) for attachment to the top of the projector.

18. The system in claim 13, wherein the system is comprised of a computer tablet case with a connector on the back of it which can be attached to the novel button connector from claim 17, and connectors on the top of it which can be attached to the stabilizing strap(s) from claim 17.

19. The method in claim 1, wherein the provisioning for the communicative resources comprises:
A human being wearing a projector or a computer tablet on the front of his/her body and thereby functionally providing by projecting and/or displaying the communicative care that is needed from that human being whether or not that human being is able to provide such care on his/her own;
A projector that will project recorded communicative interventions;
A projector that will project live communicative interventions through internet enablement;
A connectable case for a tablet that will display recorded communicative interventions;
A connectable case for a tablet that will display live communicative interventions through internet enablement.

20. The method recited in claim 1, wherein the providing of medical information is done with a qualifying caveat regarding the potential for embedded frames of the scientific paradigm and/or the limitations of the scientific paradigm.
